(19) United States
(12) Patent Application Publication
(10) Pub. No.: US 2025/0322629 A1
(43) Pub. Date: Oct. 16, 2025

(54) DIGITAL GARMENT GRADING

(71) Applicant: SPREE3D CORPORATION, Incline Village, NV (US)

(72) Inventor: Dmitriy Vladlenovich Pinskiy, Woodland Hills, CA (US)

(73) Assignee: SpreeAI Corporation, Incline Village, NV (US)

(21) Appl. No.: 18/866,637

(22) PCT Filed: May 17, 2023
(86) PCT No.: PCT/US2023/067120

§ 371 Date: Nov. 18, 2024

Related U.S. Application Data
(60) Provisional application No. 63/343,782, filed on May 19, 2022.

(51) Int. Cl. G06T 19/20

(52) U.S. Cl. CPC G06T 19/20; G06T 2210/16

(57) ABSTRACT

Apparati, methods, and computer readable media for fitting a digitized source garment onto a digitized target body, where the source garment is initially fitted to a digitized source body. A method embodiment comprises the steps of identifying a plurality of source garment points on the source garment; projecting each of the source garment points onto a corresponding point on a digitized source proxy surface; mapping the plurality of source proxy surface points to a plurality of corresponding points on a digitized target proxy surface; displacing the plurality of target proxy surface points onto a plurality of corresponding points on a digitized target garment; and digitizing the plurality of target garment points to produce a representation of the digitized target garment fitted onto the digitized target body.

### RELATED APPLICATIONS

This patent application claims the priority benefit of International Application Number PCT/US2023/067120, filed on May 17, 2023, which claims the priority benefit of U.S. Provisional Patent Application No. 63/343,782, filed on May 19, 2022, which applications are hereby incorporated by reference in their entireties herein.

### TECHNICAL FIELD

This invention pertains to the field of fitting (grading) a digitized garment to digitized models, such as human models, that have different sizes (different from each other and different with respect to the digitized garment).

### BACKGROUND ART

A conventional technique of the prior art is illustrated with reference to FIGS. 3A and 3B. The surface of a source digitized human model 1 is used as a reference to define the surface of a source digitized garment 2. More particularly, SG, the position of each vertex 23 (see FIG. 2) of the source garment 2, is projected to SH, the closest position on the source human model 1. The Displacement (offset) D between each SG and SH is recorded. Then TH, the position that is on the garmented target human model 33 and that corresponds to SH, is found. Finally, TG, the position of each vertex 23 on the target garment 34, is computed by adding the displacement D to TH.

SH and TH are not shown in FIGS. 3A and 3B, because these projections are normally hidden by garments 2, 34. In 3D space, SG and SH are co-located in areas where SG is in contact with SH. In 3D space, TG and TH are co-located in areas where TG is in contact with TH.

The above steps are repeated for every vertex 23 of the source garment 2.

This prior art technique suffers from a serious drawback. We observe that this prior art method comprises three functions—project (SG) that produces an ordered pair (delta, SH), map (SH) that finds TH corresponding to SH, and displace (delta, TH) that produces the target position TG. We note that displace (map (project (SG)))) is not a continuous (smooth) function, because it involves projection onto a human body surface, which is a highly convex surface with respect to the interior of the body. This property leads to two or more points that are within the same neighborhood on the source garment 2 possibly being projected onto very different portions of the surface of the human model 1. That in turn produces an unwanted distortion 35 on the resulting surface of the target garment 34.

FIGS. 8A and 8B show another example of this prior art method, in which the target model 33A is larger than source model 1A (rather than smaller as in the FIG. 3B example). The same observations made above with respect to FIGS. 3A and 3B can be made with respect to FIGS. 8A and 8B, with items 1A, 2A, 33A, 34A, and 35A substituted for items 1, 2, 33, 34, and 35, respectively.

### DISCLOSURE OF INVENTION

Apparati, methods, and computer readable media for fitting a digitized source garment onto a digitized target body, where the source garment is initially fitted to a digitized source body. A method embodiment comprises the steps of identifying a plurality of source garment points SG on the source garment 1; projecting each of the source garment points SG onto a corresponding point SP on a digitized source proxy surface 41; mapping the plurality of source proxy surface points SP to a plurality of corresponding points TP on a digitized target proxy surface 42; displacing the plurality of target proxy surface points TP onto a plurality of corresponding points TG on a digitized target garment 62; and digitizing the plurality of target garment points TG to produce a representation of the digitized target garment 62 fitted onto the digitized target body 33.

### BRIEF DESCRIPTION OF THE DRAWINGS

The present invention is illustrated in the accompanying drawings, in which:

FIGS. 1A and 1B illustrate a first example of the problem to be solved by the present invention.

FIG. 2 illustrates details of a digitized mesh 20 of the type used to represent models 1, 1A, 3, 3A, 33, and 33A.

FIGS. 3A and 3B illustrate a first example of the prior art technique discussed above.

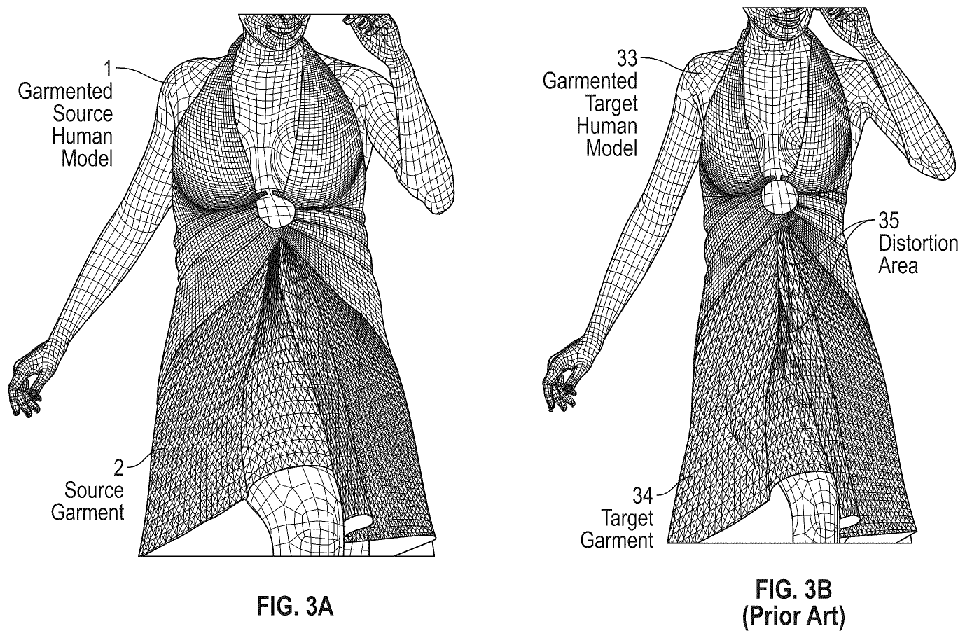

FIGS. 4A and 4B illustrate the present invention.

FIGS. 5A and 5B illustrate details of the present invention.

FIGS. 6A and 6B illustrate results obtained by the present invention.

FIGS. 7A and 7B illustrate a second example of the problem to be solved by the present invention.

FIGS. 8A and 8B illustrate a second example of the prior art technique discussed above.

FIGS. 9A and 9B illustrate an embodiment of the present invention.

FIG. 10 is an exemplary flowchart for carrying out the present invention.

FIG. 11 illustrates apparatus for implementing the present invention.

FIG. 12 is an exemplary flowchart for carrying out an embodiment of the present invention.

FIG. 13 illustrates apparatus for implementing the embodiment of the present invention that is illustrated in FIG. 12.

### DETAILED DESCRIPTION OF PREFERRED EMBODIMENTS

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and/or electrical changes can be made without departing from the scope of what is claimed. The following detailed description is, therefore, not to be taken in a limiting sense; rather, the scope of the present invention is defined by the appended claims and their equivalents.

In this patent application, the terms “a” or “an” are used to include one or more than one. In this document, the term “or” is used to refer to a nonexclusive “or,” such that “A or B” includes “A but not B,” “B but not A,” and “A and B,” unless otherwise indicated.

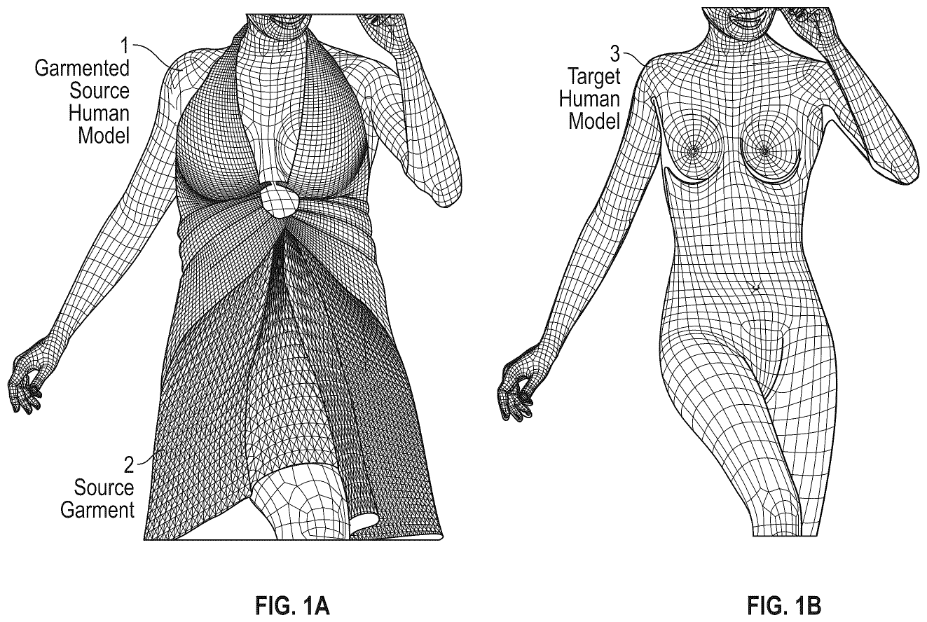

FIGS. 1A and 1B illustrate the problem to be solved by the first embodiment of the present invention. FIG. 1A shows an example of a source digitized human model 1 wearing a corresponding source digitized garment 2 that fits nicely on the digitized model 1. FIG. 1B shows a target digitized human model 3, which can be selected from an arbitrarily large set of digitized target models. In the FIG. 1 embodiment, the target model 3 is smaller than the source model 1, simply for purposes of illustrating that the target model 3 has a different dress size than the source model 1. In other instances, the target model 3 can be smaller than the source model 1, larger than the source model, or smaller in part and larger in part.

Given the digital representation of the source garmented model 1 and the digital representation of the source garment 2, the object of the present invention is to grade (fit) the source digitized garment 2 onto the target digitized model 3 without introducing any unwanted distortions 35.

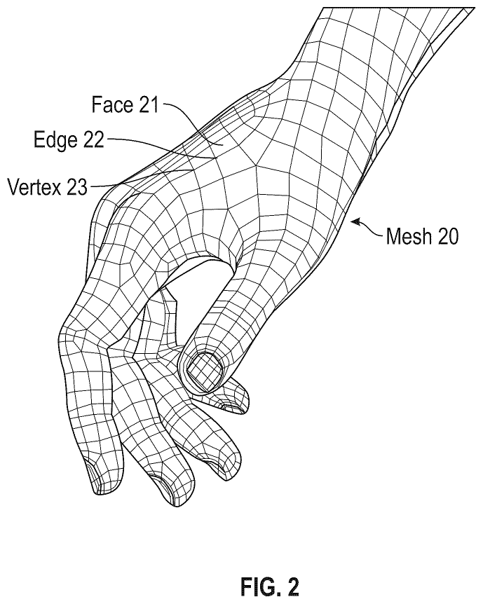

With reference to FIG. 2, all models 1, 1A, 3, 3A, 33, 33A in the illustrated embodiments are digitally represented in the form of meshes 20. The meshes 20 can be produced by any conventional means known to those of ordinary skill in the art. Meshes 20 comprise a set of vertices 23 each having a prescribed position in 3D (three dimensional) space, plus vertex 23 connectivity information, described by edges 22 and faces 21. FIG. 2 shows an example of a face 21, an edge 22, and a vertex 23 on a mesh 20 representing a digitized version of a human hand. The 3D vertices 23 can be animated, i.e., the vertices 23 can change their prescribed positions as a function of time. The tessellation shown in FIG. 2 produces a connected set of four-sided faces 21, but other types of tessellation are within the scope of the present invention, e.g., those producing three-sided faces 21 and five-sided faces 21.

The present patent application illustrates garments 2, 2A that are sleeveless dresses; however, the principles of this invention can be used to grade other types of garments 2, 2A. All models 1, 1A, 3, 3A, 33, 33A are shown in the Figures as being human females, simply for purposes of illustration. The models 1, 1A, 3, 3A, 33, 33A can also be human males, non-human animals such as cats or dogs, or inanimate objects.

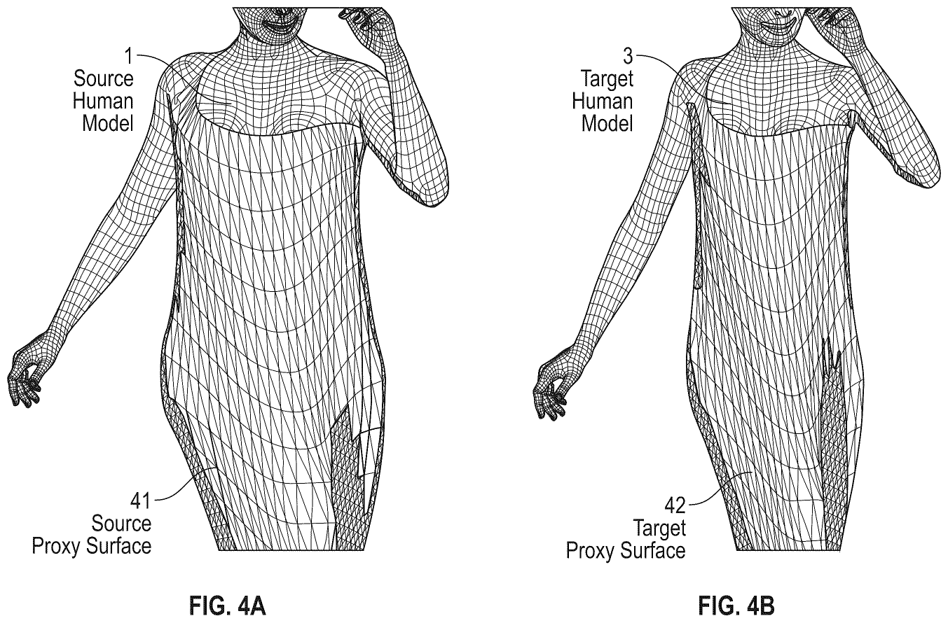

As illustrated in FIGS. 4 through 6, in the present invention we do not use the surface of the source digitized human model 1 as a reference to calculate garment 62 displacements (offsets). Instead, we create and use a novel smooth digitized proxy surface 41 that approximates the surface of the source digitized human model 1. FIG. 4A shows an example of a source digitized model 1 and a source digitized proxy surface 41. FIG. 4B shows a target digitized model 3, and a target digitized proxy surface 42. Our novel smooth proxy surface 41 meets several requirements, as follows:

Proxy surface 41 is locally convex. The surface distance between any two points SGi, SGj (which are typically vertices 23) on the source garment 2 is the scaled surface distance between two corresponding proxy-surface 41 points SPi, SPj that are used to calculate the displacements D (where D is analogous to the prior art displacements discussed above). The scale factor RS is approximately the same for any pair of source garment 2 points SGi, SGj that are within a small neighborhood (i.e., that are relatively close to each other). Thus, we are able to guarantee displacement D consistency across the source garment 2 surface.

Source proxy surface 41 and target proxy surface 42 are consistently parameterized, i.e., the lengths of their edges 22 are proportionally scaled such that the angles between said edges 22 are preserved as much as possible. Consequently, surface 41 and surface 42 have analogous properties. This is advantageous for computation and for applying displacements in a consistent manner.

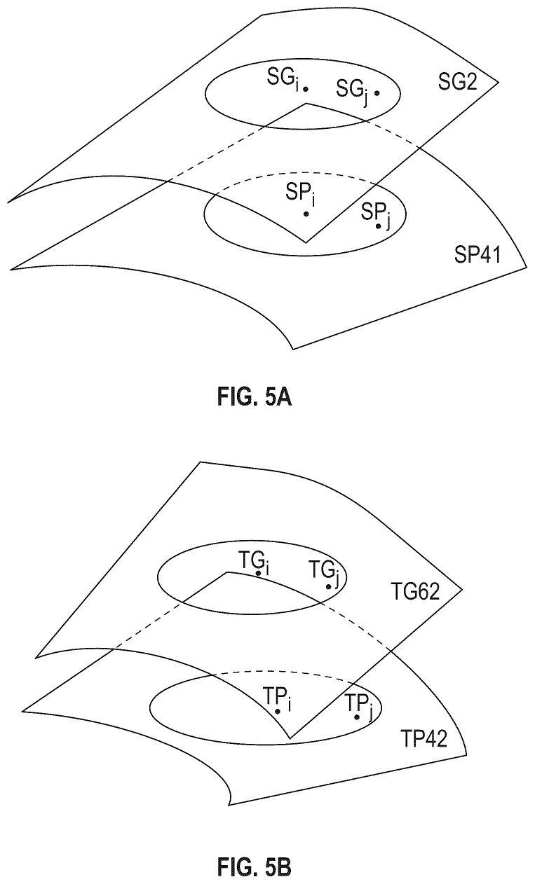

FIG. 5A shows two points, SGi and SGj (which are normally vertices 23) on the source garment 2 (SG2), and two corresponding points SPi and SPj on the source human proxy surface 41 (SP41). In reality, there are many SG's and many SP's so that the entireties of the source garment 2 and proxy surface 41 are well covered by SG's and SP's, respectively, but for purposes of illustration, only two of each SG and SP are shown.

The SP's are computed from corresponding SG's using the function “project ( )”. “Project” is a function that takes each point SG on the source garment 2 and returns, via a projection vector, the closest position SP on the source proxy surface 41, where “closest position” is given by the index of the face 21 of the source proxy surface 41 and the barycentric coordinates of the face 21. The “index” of a face 21 is the number of the face 21, or any other means for keeping track of the various faces 21 in a mesh 22. A face index is sometimes referred to as a face ID (identifier). The distance between each SG and SP is referred to as the displacement, or offset. RS, the ratio of the distance between SGi and SGj and the distance between SPi and SPj, should remain relatively the same for any pair of points (SGi, SGj) that reside within a close neighborhood:

∥SGi,SGj∥/∥SPi,SPj∥=RS

FIG. 5B shows two points TPi and TPj (which are normally vertices 23) on the target human proxy surface 42 (TP42) and two points TGi and TGj on the target garment 62 (TP62). In reality, there are many TP's and many TG's so that all parts of the target proxy surface 42 and target garment 62 are well covered by such points, but only two each of said points are shown for purposes of illustration.

The TG's are computed from the TP's using the function “displace ( )”. The displace function is the reverse of the project function. For each point TP on the target proxy surface 42, the displace function is applied, causing a displacement vector to produce a corresponding point TG on the target garment surface 62. The direction of the displacement vector is opposite to that of the projection vector. The distance between each TP and TG is called the displacement, or offset. The displacements vary from TP, TG pair to TP, TG pair. RT, the ratio of the distance between a TGi and a TGj and the distance between a TPi and a TPj, should remain relatively the same for any pair of points (TPi, TPj) that reside within a close neighborhood:

∥TGi,TGj∥/∥TPi,TPj∥=RT

FIG. 5A shows portions of SG 2 and SP 41 neighboring surfaces; and examples of SGi, SGj, SPi, and SPj. FIG. 5B shows portions of TG 62 and TP 42 neighboring surfaces; and examples of TGi, TGj, TPi, and TPj.

Proxy surfaces 41 and 42 should be smooth and parameterized consistently. That allows consistency in mapping the SP's and displacements (SG's to SP's) from the source proxy surface 41 to corresponding positions TP's and displacements (TP's to TG's) on the target proxy surface 42. There are many ways to perform the mapping step 102. One such way is based on indices of faces 21 and barycentric coordinates: the face indices and barycentric coordinates that are computed during the projection step 101, which produce the set of SP's, are applied to the target proxy surface 42 to obtain the set of TP's. The TG's are then computed by displacing 103 each TP by same magnitude of the displacement vector that was computed during the projection step 101, with the understanding that the direction of the displacement vector is opposite when deriving a TG compared with the direction of the displacement vector when deriving the corresponding SP.

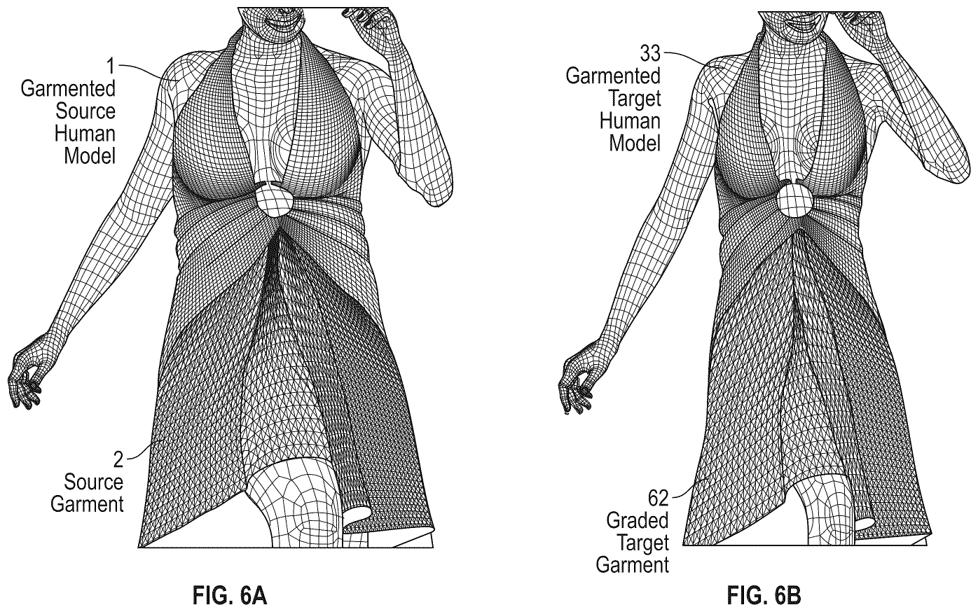

Using the above technique, the present invention produces garment grading free of undesirable corruption and distortion. FIG. 6B (corresponding to FIG. 6A) shows an example of a successful garment grading 62 that is produced by the present invention.

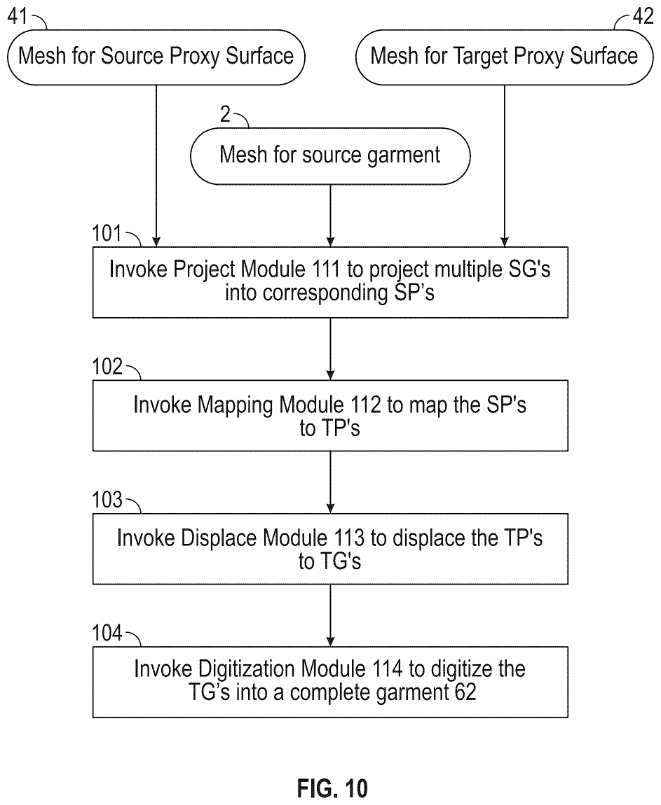

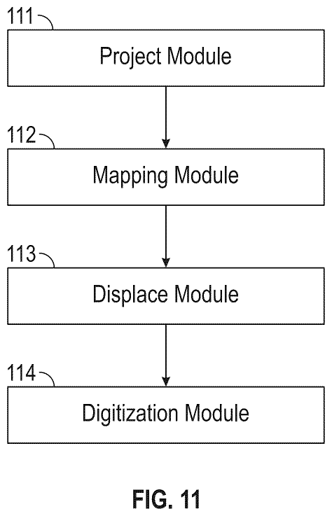

The method steps of the present invention are shown in the flowchart that is FIG. 10 (with reference to FIG. 11). The starting inputs to the method are the mesh for the source proxy surface 41, the mesh for the source garment 2, and the mesh for the target proxy surface 42. The method steps of FIG. 10 can be performed by any digital computer. At step 101, Project Module 111 is invoked to project the multiple SG's into corresponding SP's, keeping RS constant or nearly constant. At step 102, Mapping Module 112 is invoked to map the SP's into TP's. At step 103, Displace Module 113 is invoked to displace the TP's into TG's. Finally, at step 104, a conventional Digitization Module 114 is invoked to convert the TG's into a complete digitized garment 62.

FIG. 11 shows the Project Module 111, Mapping Module 112, Displace Module 113, and Digitization Module 114 that are referred to in FIG. 11. These modules 111, 112, 113 can be implemented in any combination of computer hardware, software, and/or firmware.

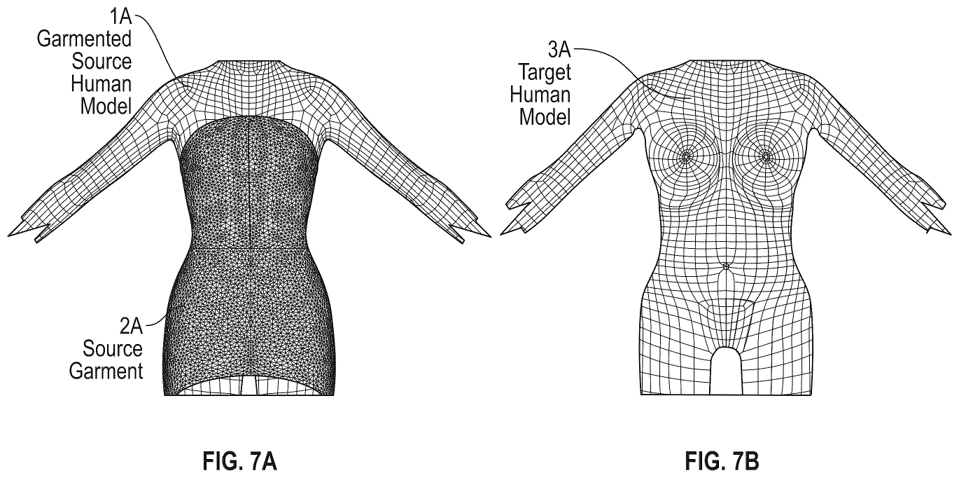

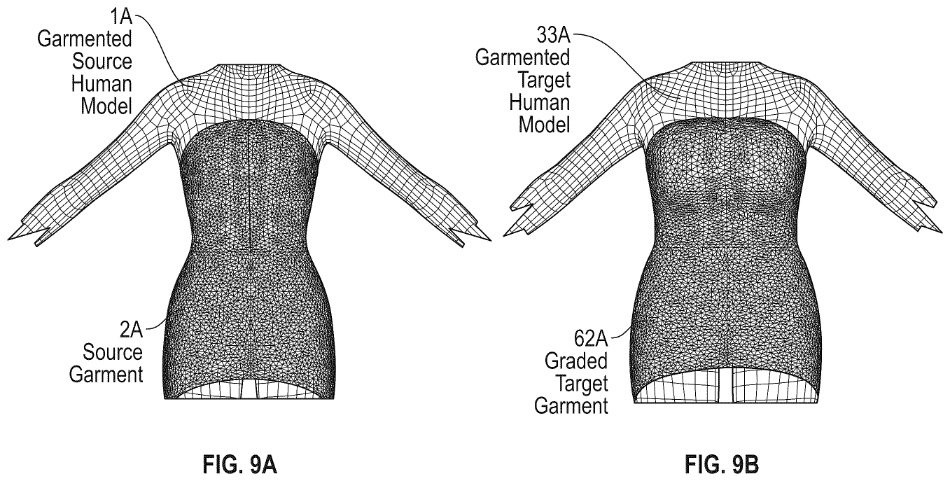

An embodiment of the present invention, which serves to help preserve the edge 22 flow in the tessellation, is illustrated with respect to FIGS. 7 and 9. In FIG. 7A, the source digitized model 1A is similar to source digitized model 1, while source garment 2A is different than source garment 2. FIG. 7B shows that the target human model 3A is larger than the source model 1A, simply for purposes of illustration. In other instances, model 3A can smaller than model 1A, or larger in part and smaller in part.

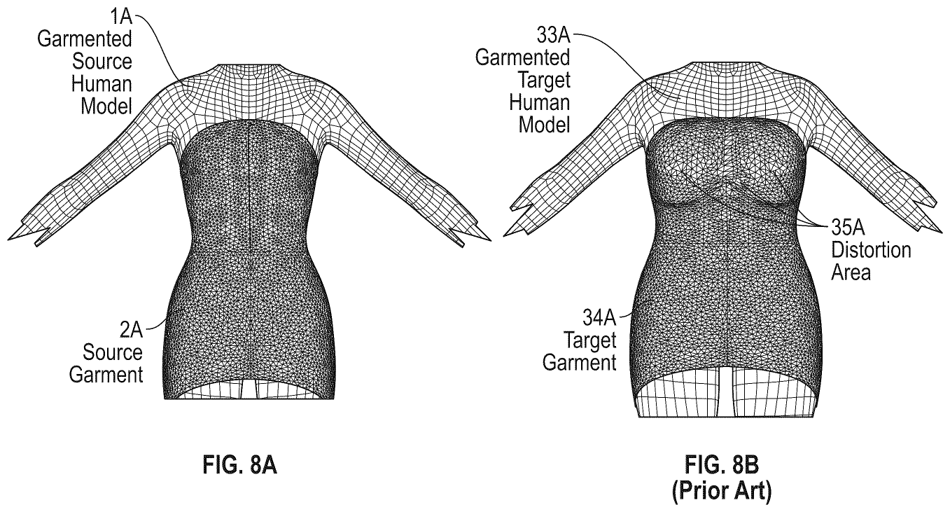

FIG. 9A is identical to FIG. 7A. With reference to FIG. 9B, in this embodiment of the present invention, we have introduced an extra series of steps 121, 122, 123 to restore the surface curvature of the source garment 2A onto the surface of target garment 62A as much as possible, without introducing the troublesome intersections 35A between the target garment 34A and the garmented target human model 33A that are present in the prior art exemplified by FIG. 8B.

In this embodiment of the present invention, the angles formed by edges 22 of mesh 20 of a preliminary version of target garment 62A are compared 121 with the corresponding angles formed by edges 22 of mesh 20 of the source garment 2A. Then the vertices 23 of the preliminary version of target garment 62A are moved 122 to minimize the difference between each pair of corresponding angles, to produce the final version of the vertices 23, which are then aggregated 123 to produce the final graded target garment 62A.

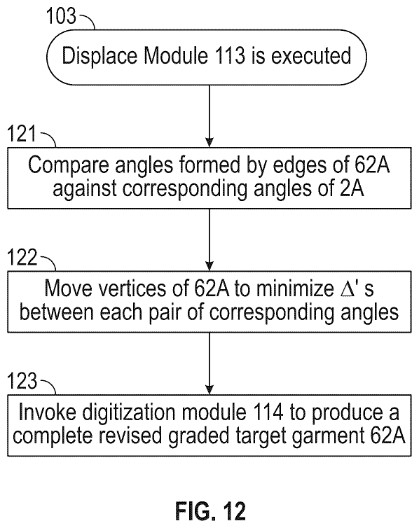

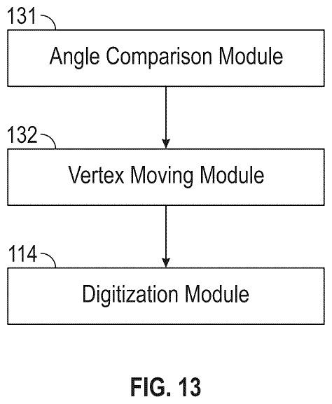

FIG. 12 (referring to FIG. 13) illustrates, in the form of a flowchart, the method of this embodiment of the present invention. The starting point of this embodiment is the output of step 103 (see FIG. 10 and accompanying description). The method steps of FIG. 12 can be performed by any digital computer. At step 121, Angle Comparison Module 131 is invoked to compare the angles formed by the edges 22 of the preliminary version of target garment 62A against corresponding angles formed by the edges 22 of source garment 2A. Then at step 122, Vertex Moving Module 132 is invoked to move the vertices 23 from the preliminary version of target garment 62A in a way that minimizes the differences between each pair of corresponding angles from garments 2A and 62A. Thus, step 122 produces a revised set of vertices 23 for a revised final version of graded target garment 62A. Finally, in step 123, conventional Digitization Module 114 (which can be the same module as in FIG. 10) is invoked to produce a complete final version of graded target garment 62A based upon the revised set of vertices 23 produced by step 122.

FIG. 13 shows the Angle Comparison Module 131, Vertex Moving Module 132, and Digitization Module 114 that are referred to in FIG. 11. These modules 131, 132, 114 can be implemented in any combination of computer hardware, software, and/or firmware.

When this embodiment is used, models 1, 1A should share the same mesh 20 topology, defined by the number of vertices 23 and by the vertex 23 connectivity, which in turn is defined by the various faces 21 and edges 22. The resulting graded (target) garments 62, 62A will then have the same number of vertices 23 as the source garments 2, 2A, with different positions for at least a subset of the vertices 23.

The method steps of the present invention as described above can be embodied as computer program instructions residing on a computer readable medium. While the computer readable medium can be a single medium, the term “computer readable medium” is to be construed to include a single medium or multiple media (e.g., a centralized or distributed database, and/or associated caches and servers) that store the one or more sets of computer program instructions. The term “computer readable medium” shall also be construed to include any medium that is capable of storing, encoding, or carrying out a set of instructions for execution by the computer and that causes the computer to perform any one or more of the methods of the present invention, or that is capable of storing, encoding, or carrying data utilized by or associated with such a set of instructions. The term “computer readable medium” shall accordingly be construed to include, but not be limited to, solid-state memories, optical media, and magnetic media. Such media can include, without limitation, hard disks, floppy disks, flash memory cards, digital video disks, random access memory, read only memory, and the like.

The example embodiments of the present invention described in this patent application can be implemented in an operating environment comprising computer-executable instructions installed on a computer, in software, in hardware, or in any combination of software and hardware. The computer-executable instructions can be written in a computer programming language or can be embodied in firmware logic. If written in a programming language conforming to a recognized standard, such instructions can be executed on a variety of hardware platforms, and for interfaces to a variety of operating systems. Although not limited thereto, computer software programs for implementing the present method can be written utilizing any number of suitable programming languages such as, for example, HyperText Markup Language (HTML), Dynamic HTML, Extensible Markup Language, Extensible Stylesheet Language, Document Style Semantics and Specification Language, Cascading Style Sheets, Synchronized Multimedia Integration Language, Wireless Markup Language, Java™, Jini™, C, C++, C#, Go, .NET, Adobe Flash, Perl, UNIX Shell, Visual Basic, Visual Basic Script, Virtual Reality Markup Language, ColdFusion™, Objective-C, Scala, Clojure, Python, JavaScript, HTML5, or other compilers, assemblers, interpreters, or other computer languages or platforms, as one of ordinary skill in the art will recognize.

The above description is included to illustrate the operation of preferred embodiments, and is not meant to limit the scope of the invention. The scope of the invention is to be limited only by the following claims. From the above discussion, many variations will be apparent to one skilled in the art that would yet be encompassed by the spirit and scope of the present invention. For example, the target models 3, 3A, 33 can have not just different sizes, but also different poses; or different sizes and different poses.

What is claimed is:

1.-13. (canceled)

14. A method comprising:
identifying a plurality of source garment points on a digitized source garment;
projecting each source garment point onto a corresponding point on a digitized source proxy surface to generate a plurality of source proxy surface points, the source proxy surface being a smoothed version of a digitized source body;
mapping the plurality of source proxy surface points to a plurality of corresponding points on a digitized target proxy surface of a digitized target body to generate a plurality of target proxy surface points;
displacing the plurality of target proxy surface points onto a plurality of corresponding points on a digitized target garment to generate a plurality of target garment points; and
digitizing the plurality of target garment points to produce a representation of the digitized target garment fitted onto the digitized target body.

15. The method of claim 14, wherein the digitized source body and the digitized target body are human bodies having at least one of different sizes or different poses.

16. The method of claim 14, wherein for each pair of neighboring source garment points on the digitized source garment and corresponding source proxy surface points, a ratio of a first distance between the pair of neighboring source garment points and a second distance between the corresponding source proxy surface points is approximately equal to one.

17. The method of claim 14, wherein each of the digitized source body, digitized source garment, and digitized target body comprises a mesh having a plurality of vertices represented by barycentric coordinates, a corresponding plurality of indexed multi-sided faces, and a corresponding plurality of edges.

18. The method of claim 17, wherein the mapping step comprises:
applying the face indices and barycentric vertex coordinates of the plurality of source proxy surface points from the projecting step to the target proxy surface to locate the plurality of target proxy surface points; and
executing the displacing step to obtain the plurality of target garment points, wherein a first distance from each target proxy surface point to a corresponding target garment point is the same as a second distance from a corresponding source garment point to a corresponding source proxy surface point.

19. The method of claim 17, wherein each source garment point is a vertex on the source garment mesh.

20. The method of claim 14, wherein the source proxy surface and the target proxy surface are parameterized consistently.

21. The method of claim 14, wherein:
the digitized source garment is represented by a mesh having a plurality of vertices and edges; and
the method further comprises performing the following steps after performing the displacing step:
comparing angles formed by edges in the source garment mesh against angles formed by corresponding edges in an intermediate target garment mesh having a plurality of vertices and edges;
moving vertices in the intermediate target garment mesh to minimize the differences between each pair of corresponding angles; and
using the moved vertices to produce a revised graded digitized target garment.

22. An apparatus comprising one or more processors configured to:
identify a plurality of source garment points on a digitized source garment;
project each source garment point onto a corresponding point on a digitized source proxy surface to generate a plurality of source proxy surface points, the source proxy surface being a smoothed version of a digitized source body;
map the plurality of source proxy surface points to a plurality of corresponding points on a digitized target proxy surface of a digitized target body to generate a plurality of target proxy surface points;
displace the plurality of target proxy surface points onto a plurality of corresponding points on a digitized target garment to generate a plurality of target garment points; and
digitize the plurality of target garment points to produce a representation of the digitized target garment fitted onto the digitized target body.

23. The apparatus of claim 22, wherein the digitized source body and the digitized target body are human bodies having at least one of different sizes or different poses.

24. The apparatus of claim 22, wherein for each pair of neighboring source garment points on the digitized source garment and corresponding source proxy surface points, a ratio of the a first distance between the pair of neighboring source garment points and a second distance between the corresponding source proxy surface points is approximately equal to one.

25. The apparatus of claim 22, wherein each of the digitized source body, digitized source garment, and digitized target body comprises a mesh having a plurality of vertices represented by barycentric coordinates, a corresponding plurality of indexed multi-sided faces, and a corresponding plurality of edges.

26. The apparatus of claim 25, wherein the one or more processors are configured to perform mapping by:
applying the face indices and barycentric vertex coordinates of the plurality of source proxy surface points from the projecting step to the target proxy surface to locate the plurality of target proxy surface points; and
executing the displacing step to obtain the plurality of target garment points, wherein a first distance from each target proxy surface point to a corresponding target garment point is the same as a second distance from a corresponding source garment point to a corresponding source proxy surface point.

27. The apparatus of claim 25, wherein each source garment point is a vertex on the source garment mesh.

28. The apparatus of claim 22, wherein the source proxy surface and the target proxy surface are parameterized consistently.

29. The apparatus of claim 22, wherein:
the digitized source garment is represented by a mesh having a plurality of vertices and edges; and
the method further comprises performing the following steps after performing the displacing step:
comparing angles formed by edges in the source garment mesh against angles formed by corresponding edges in an intermediate target garment mesh having a plurality of vertices and edges;
moving vertices in the intermediate target garment mesh to minimize the differences between each pair of corresponding angles; and
using the moved vertices to produce a revised graded digitized target garment.

30. At least one non-transitory computer-readable medium containing computer-executable instructions that, when executed by one or more processors, cause the one or more processors to:
identify a plurality of source garment points on a digitized source garment;
project each source garment point onto a corresponding point on a digitized source proxy surface to generate a plurality of source proxy surface points, the source proxy surface being a smoothed version of a digitized source body;
map the plurality of source proxy surface points to a plurality of corresponding points on a digitized target proxy surface of a digitized target body to generate a plurality of target proxy surface points;
displace the plurality of target proxy surface points onto a plurality of corresponding points on a digitized target garment to generate a plurality of target garment points; and
digitize the plurality of target garment points to produce a representation of the digitized target garment fitted onto the digitized target body.

31. The at least one non-transitory computer-readable medium of claim 30, wherein each of the digitized source body, digitized source garment, and digitized target body comprises a mesh having a plurality of vertices represented by barycentric coordinates, a corresponding plurality of indexed multi-sided faces, and a corresponding plurality of edges.

32. The at least one non-transitory computer-readable medium of claim 31, wherein the one or more processors perform mapping by:
applying the face indices and barycentric vertex coordinates of the plurality of source proxy surface points from the projecting step to the target proxy surface to locate the plurality of target proxy surface points; and
executing the displacing step to obtain the plurality of target garment points, wherein a first distance from each target proxy surface point to a corresponding target garment point is the same as a second distance from a corresponding source garment point to a corresponding source proxy surface point.

33. The at least one non-transitory computer-readable medium of claim 31, wherein each source garment point is a vertex on the source garment mesh.
